(19) United States
(12) Patent Application Publication
(10) Pub. No.: US 2007/0036705 A1
(43) Pub. Date: Feb. 15, 2007

(54) Hollow silica particles and methods for making same

(76) Inventors: Matthew David Butts, Rexford, NY (US); Sarah Elizabeth Genovese, Delmar, NY (US); Paul Burchell Glaser, Niskayuna, NY (US); Darryl Stephen Williams, Albuquerque, NM (US)

Correspondence Address: GEAM - SILICONES - 60SI;IP LEGAL, ONE PLASTICS AVENUE, PITTSFIELD, MA, 01201-3697, US

(21) Appl. No.: 11/200,917

(22) Filed: Aug. 10, 2005

(51) Int. Cl. C01B 33/12

(52) U.S. Cl. 423/335

(57) ABSTRACT

Methods for making hollow silica particle are disclosed, said particles made from a composition comprising a silicon-containing compound selected from the group consisting of tetraalkoxysilanes, trialkyloxysilanes and derivatives thereof, dialkoxysilanes and derivatives thereof, alkoxysilanes and derivatives thereof, silicone oligomers, oligomeric silsesquioxanes and silicone polymers distributed over a polymer template core that is eliminated from the particle. The particles of the present invention have a substantially uniform particle size and exhibit low permeability to liquids.

### FIELD OF INVENTION

The present invention relates generally to the field of silica particle synthesis. More specifically, the present invention relates to the field of synthesizing substantially uniform silica-based particles for use in personal care products which encapsulate a hollow interior.

### BACKGROUND OF THE INVENTION

In the personal care industry, particularly with respect to personal care products for skin, there is a need for ingredients that provide coverage for age spots, blemishes, discolorations, etc., as well as provide a natural look. It is a well known problem that cosmetic products that provide good coverage have a mask-like, unnatural appearance. This is particularly true with titanium dioxide-based materials, the most common type of opacifiers found in cosmetics. Many cosmetic compositions have been reported that provide high coverage with some degree of “naturalness”, however none have provided the level of naturalness that is highly desired by consumers without sacrificing the required coverage.

Examples of hollow particles have been previously described. However, previously described materials have significant shortcomings as potential opacifiers in cosmetic formulations. Co— and terpolymer systems made from vinylidene chloride and acrylonitrile, or from vinylidene chloride, acrylonitrile and methylmethacrylate have been reported (e.g. Expancel™). Unfortunately these types of materials are only readily available in particle sizes that exceed the sizes believed necessary to achieve maximum optical performance benefits in cosmetic uses. Styrene/acrylate hollow particles (e.g. Ropaque™, Rohm & Haas) are also known, however these particles do not provide the desired optical benefits in cosmetic formulations.

Hollow particles with polymer shells can be made by creating core/shell particles containing a core with hydrolyzable acid groups and a sheath, or shell, that is permeable to a base. Hollow particles with silica shells synthesized using a layer-by-layer electrostatic deposition technique on a template are also known. In addition, hollow particles have also been synthesized by depositing nanoparticles derived from alkoxysilanes on a template particle, as well as by condensation of sodium silicate on a template particle followed by template removal. However, such particles often show a lack of continuity in the particle surface and thus often exhibit unacceptable shell permeability. Further, none of the known and reported particles have been made according to a method that allows for creation of the particles in a desired, substantially uniform, narrow range with narrow particle size distributions and having acceptable permeability, or they otherwise involve numerous synthetic steps which make their production impractical for use in personal care applications.

### SUMMARY OF THE INVENTION

It has surprisingly been found that, in cosmetic formulations, hollow particles produced within a certain, predetermined particle size range, with a narrow particle size distribution, and exhibiting low permeability are capable of concurrently providing high coverage as well as a more natural appearance relative to known cosmetic formulations.

The present invention relates to a hollow silica particle made from a composition comprising a silicon-containing compound incorporating silicon atoms derived from one or more silicon compounds including tetraalkoxysilanes, trialkoxysilanes, dialkoxysilanes, alkoxysilanes, silicone oligomers, oligomeric silsesquioxanes, silicone polymers, and derivatives and mixtures thereof. These silicon compounds optionally can be functionalized with any organic group or mixture of groups, provided that such groups do not interfere with the production of the particles. The particles of the present invention have a substantially uniform particle size.

The present invention further relates to a method for making a hollow silica-containing particle. A template particle, such as, but not limited to, a polymer template particle, is created and characterized by having a narrow particle size distribution. A silane coupling agent is provided to the template mixture. A silicon-containing compound or mixture of compounds is then added and allowed to react under conditions that cause the deposition of a silica-containing shell onto the template particle to create a substantially uniform coating on the template particle. The template particle core is then eliminated from the resulting particle via heating, dissolution, or extraction, and preferably via a two step heating process, leaving a hollow silica particle having a shell with a substantially constant thickness, desired, low level of permeability to liquids, white in color, and an overall narrow particle size distribution range.

### BRIEF DESCRIPTION OF THE DRAWINGS

FIG. 1 is a schematic chemical reaction representation of one preferred method of the present invention.

FIG. 2 is a photomicrograph showing the template particles formed according to one embodiment of the present invention.

FIG. 3 is a photomicrograph of one embodiment of the present invention showing the hollow silica particles.

### DETAILED DESCRIPTION OF THE DRAWINGS

The process for making the hollow particles of the present invention includes preparing a template particle, depositing a silica-containing shell onto the particle, and then removing the template material, leaving the hollow silica-containing shell of a predetermined, substantially similar dimension and having an acceptably low permeability to liquids. Acceptable permeability is that which allows for the preparation of cosmetic or other compositions that maintain their optical properties for a sufficient time period. Preferably, the template particle, having a certain, predetermined, particle size, with a predetermined, substantially narrow particle size distribution range, is made under emulsion, dispersion or suspension polymerization conditions. The template particle can be comprised of any material that is able to be removed through heating, dissolution, or extraction following shell deposition. Preferably this template particle is a polymer latex particle, such as those comprising polystyrene or other styrenic polymers.

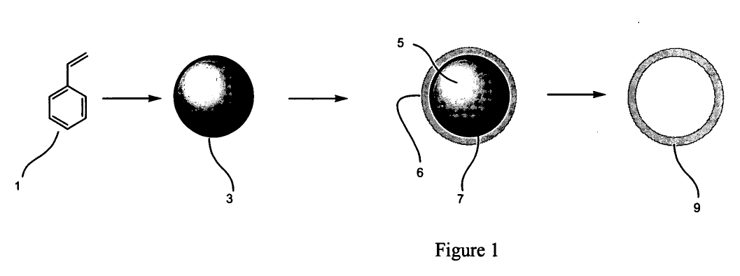

As shown in FIG. 1, according to one preferred embodiment of the present invention, a template polystyrene particle 3 is prepared by polymerizing styrene 1 under certain conditions. Such reaction conditions include heat treatment, and addition of certain reactants. By selecting the appropriate reactant, concentration, temperature, and processing conditions, such as stir rate and stirrer design, template particles 3 are formed having a particle size that averages between about 200 nm and about 700 nm in diameter. Once the template particles 3 are formed, they are treated with a coupling agent followed by a silicon-containing compound or mixture of compounds under specific pH and temperature conditions to deposit a substantially uniform silica-containing coating 6 onto the particle template to form a coated particle 5 having a coating 6 and a polystyrene core 7. The coated particle 5 is then isolated and heated under specified conditions to eliminate the core 7, resulting in the desired end-product; a substantially uniform hollow silica particle 9 and a byproduct of styrene and styrene oxidation products (not shown in figure).

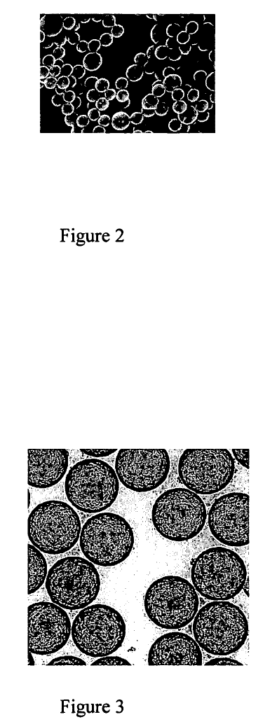

FIG. 2 is a photomicrograph showing polystyrene template particles prepared according to one embodiment of the present invention, which have an average diameter of about 500 nm and a narrow particle size distribution. Finally, FIG. 3 is a photomicrograph of the final product of the present invention; substantially uniform hollow silica particles having an average particle size of about 500 nm with a narrow particle size distribution.

In accordance with one preferred embodiment of the present invention, the preferred average template particle size, controlled by the emulsion, dispersion or suspension polymerization conditions, is preferably from about 200 nm to about 700 nm in diameter, and more preferably from about 250 to about 600 nm. The ideal particle size distribution is such that at least 25% of the particles are within the range of about 200 nm to about 700 nm, preferably at least 50%, as determined by image analysis. Thus the ideal distribution depends on the average particle size. The template particle can comprise any monomer or polymer material that allows for removal of the polymer core following shell deposition. Suitable template materials include styrenic polymers, acrylate polymers, and related copolymeric systems. Preferably, styrene, derivatives of styrene such as alphamethylstyrene, or mixtures of styrene and styrene derivatives are used as monomer in the emulsion, dispersion, or suspension polymerization reaction. More preferably, styrene is used as the sole monomer or styrene/alphamethylstyrene mixtures, and, most preferably, styrene is used alone.

As outlined in FIG. 1, the preferred template latex is optionally synthesized in the absence of a surfactant, but it should be noted that the template synthesis can be carried out in the presence of any surfactant or mixture of surfactants that do not interfere with the emulsion, dispersion, or suspension polymerization reaction. Preferably, the surfactant or mixture of surfactants is anionic in nature. More preferably, the surfactant or mixture of surfactants is selected from alkyl sulfates, alkyl sulfonates, linear alkyl arylsulfonates, or a combination of any of these. Most preferably, the surfactant is sodium dodecylsulfate, sodium dodecylbenzenesulfonate or a mixture thereof. Preferably, an initiator is added to the template particle synthetic reaction. Particularly preferred initiators include, but are not limited to, persulfate salts, organic hydroperoxides and, azo initiators.

The emulsion, dispersion, or suspension polymerization reaction is preferably carried out in a temperature range between preferably from about 25° C. to about 150° C., more preferably between from about 50° C. to about 100° C. and most preferably at about 70° C. In one embodiment, surfactant is used in the preparation of the template particles. If surfactant is used, its identity and concentration are chosen such as to not significantly interfere with the subsequent shell deposition step, thus allowing the latex to be used as produced in the shell deposition step. Optionally, the surfactant can be removed by isolating and washing the template particles or by passage of the reaction mixture through a suitable ion-exchange resin before performing the shell deposition step, although this is not necessarily a preferred method. If this method is chosen, after the washing is complete, the latex template can be re-suspended in water. In another embodiment, the polystyrene latex is prepared in the absence of surfactant and is used as produced in the shell deposition step.

For the shell deposition step, the polystyrene latex mixture is typically diluted to a concentration appropriate for the shell deposition step. The concentration in percent solids is typically in the range of about 0.1 to about 50%, preferably from about 2 to about 30%. The polystyrene latex mixture is typically heated to elevated temperatures. For example, when tetraethoxysilane is used as the silicon-containing compound, the temperature is preferably in the range of from about 20° C. to about 150° C., more preferably between from about 45° C. to about 90° C. and most preferably about 50° C.

Preferably, the pH is adjusted, with the ideal pH depending on the nature of the silicon-containing compound or mixture of compounds being added in the shell deposition step. For example, for tetraethoxysilane, the reaction mixture pH preferably is in the range of from about 8 to about 12, more preferably in the range of from about 9 to about 11, and most preferably in the range of from about 10 to about 10.5. The pH adjustment can be achieved with any suitable acid (for the low pH preferred with certain silicon-containing compounds) or base known to those skilled in the art. For example, ammonium hydroxide is a preferred choice when a tetraalkoxysilane, such as tetraethoxysilane, is used.

After pH adjustment, but before adding the silica-containing compound to deposit the shell, it may be advantageous to add a compatibilizer, such as a silane coupling agent. Suitable compatibilizers for polystyrene template particles include phenyltrimethoxysilane, (3-aminopropyl)triethoxysilane, or a combination of the two. Any coupling agent capable of promoting the deposition of a silica-containing shell on the surface of the template particles can be used.

Following the addition of the coupling agent to the polystyrene latex mixture, the shell precursor silicon-containing compound(s) are added with stirring to deposit the silica-containing shell. The preferred silicon-containing material is a tetraalkoxysilane, such as tetraethoxysilane, tetrapropoxysilane or tetramethoxysilane, and is preferably tetraethoxysilane or tetramethoxysilane. Use of partially condensed alkoxysilanes, such as partially condensed ethoxysilanes and other alkoxy-containing oligomers or polymers are also considered to be within the scope of the current invention. The preferred rate of addition of the silicon-containing compound depends on the identity of the compound. For example, for tetraethoxysilane the addition is preferably done slowly, within 3 to 48 hours, preferably within about 24 hours. When the silicon-containing compound is tetramethoxysilane, the addition is preferably completed within 30 minutes to 16 hours. The silicon-containing compound can be diluted in a solvent prior to addition, such as in the case where tetraethoxysilane is diluted in ethanol, although this is not necessary. It may be desired to dilute the silicon-containing compound in an alcohol or alcohol mixture, however, with some tetraalkoxysilanes such as tetrapropoxysilane. The amount of silicon-containing compound that is added to the template particle dispersion, as a weight percent with respect to the weight of the template particles, depends on the chemical nature of the silicon-containing compound and the efficiency of the deposition. The ideal amount is the least amount required to isolate core/shell particles with the desired shell thickness and characterized by a sufficient purity for the desired application. The “desired shell thickness” is defined in terms of the final particle performance desired. For the application of the current invention, it is desired that the shells be thin enough to allow for the removal of the core, and also thick enough to withstand mechanical manipulation and subsequent formulation without losing structural integrity. The shells produced according to the present invention are typically between about 10 and about 30 nm thick, and more typically between about 15 and about 25 nm thick. After the addition of the silicon-containing compound is complete, the reaction can optionally be allowed to continue stirring before particle isolation.

The core/shell particles are isolated by either centrifugation or filtration. According to one embodiment of the present invention, centrifugation is preferred due to the superior ability to isolate more pure product devoid of solid, colloidal SiO₂. Indeed, according to one embodiment of the present invention, it is preferred that the centrifuge regimen is closely observed. No dual separation is needed, and the colloidal SiO₂ present in the optically clear mother liquor does not contaminate the isolated product with the centrifuge set to apply a force to the sample of from about 5,000 to about 20,000 g for a period of from about 5 minutes to about 1 hour, more preferably at a force of about 15,000 g for a period of from about 10 to about 15 minutes. Subjection of the particles in the reaction mixture to these centrifuge parameters results in a substantial amount of the colloidal SiO₂ being retained in suspension and poured off, leaving a more pure product in the sediment. Filtration is also an option, provided that the method allows for the isolation of particles that, in the end, provide the desired benefits. The core/shell particles can optionally be washed and reisolated, but this is not necessary.

After isolation of the coated particles, the core material is removed. Preferably, the removal is achieved by heating the core/shell particles in two stages. The first stage includes heating the particles to a temperature at which template depolymerization and volatilization is favored and holding the temperature substantially constant for a time sufficient to produce particles that are white in color and have the desired optical properties at the end of the completed heating regimen. After the first “hold” temperature, it is advantageous to heat the particles to a higher temperature for a time long enough to densify the shells. Obtaining the hollow particles that are white in color is a preferred embodiment of the present invention when the particles are to be incorporated into a cosmetic product. Particles having acceptable whiteness are characterized by TAPPI Brightness values (T-452 Brightness (1987) method) of preferably greater than or equal to about 0.5, more preferably greater than or equal to 0.55, and most preferably greater than or equal to 0.6. It is also preferred that the hollow particles of the present invention be substantially impermeable to liquid penetration through the shell under conditions of use. Densification of the shell according to the core removal heating regimen of the present invention provides hollow particles having the desired impermeability.

There is no need to cool the material between stage one and stage two. The ideal stage one temperature depends on the identity of the monomer or monomer mixture as well as the characteristics of the resulting polymer used to prepare the template particles as well as the design and mass transport properties of the oven. For the case where polystyrene latex is used as the material for the template particles, stage one includes heating to a temperature preferably in a range of from about 325° C. to about 525° C., more preferably between from about 375° C. to about 475° C., and most preferably to about 425° C. The sample is held at the stage one temperature for a time period preferably of from about 1 to about 8 hours, more preferably from about 2 to about 6 hours and most preferably for about 4 hours. Regardless of whether the template particles are made from styrene or mixtures of derivatives thereof, the stage two temperature is preferably in the range preferably of from about 525° C. to about 900° C., preferably between from about 550° C. to about 700° C. and most preferably about 600° C. The stage two temperature is held for about 1 to 8 hours, preferably for about 2 to 6 hours. The desired length of time for which the temperature stages are held depends in part on the gas flow rate in the oven and other parameters that affect mass transfer and thus the suggested hold times are not meant to be limiting, but rather are offered as examples. The temperature ramp and decline rates are not critical to the performance of the final product, provided that the ramp rate(s) do not contribute to the introduction of color in the final product. Temperature ramp and decline rates are typically in the range from about 0.1° C./min to about 25° C./min, preferably in the range of from about 1° C./min to about 10° C./min. The heating steps can be carried out under an oxygen-containing atmosphere or an inert atmosphere. The flow rate of the atmosphere is not critical provided that it is sufficient to avoid deposition of template decomposition products onto the particles during the heat treatment, which would introduce unwanted color. An alternate core/shell particle heating system is a fluidized bed furnace, which can also be a preferred method of core removal. It is further understood that gas flow rate could be altered to improve core removal times, however practical flow rate limits would be readily understood by one skilled in the field to avoid loss of product due to the fact that the hollow particle product is lightweight. Alternatively, the core can be removed by dissolution or solvent extraction. If dissolution is used as the method for core removal, it may be advantageous to follow particle isolation with the stage two heating protocol to densify the shells.

It has now been determined that in one embodiment of the present invention that allows for the production of hollow silica particles with the desired properties for cosmetic applications includes the use of polystyrene latex, synthesized by emulsion, dispersion, or suspension polymerization, as the template particles. This preferred method allows for tight control over particle size and particle size distribution, which is important for achieving the desired optical effects of the resultant cosmetic product incorporating the particles of the present invention. This use of polystyrene latex further provides for the eventual removal of the template from the silica-coated core/shell product by heating. Further advantageous features include the use of a silane coupling agent to promote the deposition of silica on the core surface, as well as the controlled addition of the silicon-containing compound at a specific and controlled pH and temperature. Use of a compatibilizer as well as controlling the addition rate of the alkoxysilane, the reaction pH and the temperature allows for condensation and deposition of the silica on the surface of the particle to be sufficient relative to condensation/particle formation in the bulk solution. This is important because condensation of silica to form solid particles in the bulk solution does not yield a silica coated template and therefore, in the end, a hollow particle. Silica particles that are produced in the bulk solution are separated from the desired product according to one method of the present invention. Further, the heating protocol defined in this invention allows for the removal of the template material efficiently, without the introduction of unwanted color. Significantly, the method of the current invention allows for the isolation of hollow silica exhibiting low permeability to liquids such as, but not limited to, water and decamethylcyclopentasiloxane (sold commercially as SF1202, available from General Electric Company, NY) under conditions of use in cosmetic and other compositions. These aspects of hollow particle synthesis provide a material that, when formulated in certain media such as a cosmetic formulation, provide both enhanced coverage and perceptibly superior naturalness. The liquid permeability of the particles of the present invention has been determined to be acceptable relative to specific liquid permeability tests. To be acceptable for use in cosmetics, the finished hollow particles of the present invention must have extremely low liquid permeability, or, in other words, be substantially impermeable to decamethylcyclopentasiloxane. The particles are said to be substantially impermeable to decamethylcyclopentasiloxane when about 90 to about 100% of a particle sample of from about 50 to 100 mg floats in a 10-15 mL sample of decamethylcyclopentasiloxane for a time period of at least about 30 days. As used herein, “hollow particles” are those that remain substantially or partially hollow when placed in or when contacted with liquids, that is there remains a continuous hollow void of substantial size when placed in or contacted with liquids. The interior hollow portion of the particle does not substantially fill or take up fluids or liquids such as fragrances, oils, materials for controlled release, water, or other fluids which may be present in the formulation. Product satisfying this float test is known to display a useful shelf life of at least about 7 months when incorporated into a cosmetic product.

After isolation, the hollow particles may be functionalized by reaction with any monomeric, oligomeric or polymeric material, or mixture thereof, that is capable of reacting or interacting significantly with the surface of the hollow particles. For example, functional silanes, silazanes, or silicone oligomers or polymers can be allowed to react with surface silanols present on the particle surface. Such suitable materials include trialkoxy- or triaryloxysilanes, dialkoxy- or diaryloxysilanes, alkoxy- or aryloxysilanes, derivatives thereof (i.e., oligomeric or polymeric), or mixtures thereof, as well as reactive silicon-containing materials, such as hexamethyldisilazane. The functionality present on the reactive silane, oligomer or polymer can be chosen to modify the dispersibility of the particles, improve their stability in formulation, to improve their compatibility with other formulation ingredients, or provide functionality that adds other consumer appreciated benefits, such as optical or other sensory benefits (e.g. soft feel). In the case of alkoxysilanes or aryloxysilanes, additional functionality may be incorporated such as alkyl, aryl, olefin, ester, aine, acid, epoxide, alcohol and the like. One preferred functionalization reaction is that which occurs upon allowing the hollow silica particles to react with hexamethyldisilazane. This reaction can be carried out in a liquid reaction mixture or in the absence of solvent between the dry material and hexamethyldisilazane in the vapor state.

The advantages of the synthetic method described herein include predictable control of particle size, control of shell thickness, the ability to functionalize the surface, and the ability to create a continuous shell having a substantially uniform thickness. The performance benefits in personal care products afforded by the particles of the present invention include, for example, high coverage and a natural look when formulated as a cosmetic product. The ability to functionalize the surface of the particles offers advantages in particle dispersibility, stability in and out of formulation, compatibilization, and the ability to add additional consumer relevant benefits, such as optical effects.

The hollow silica particles or “shells” of the present invention may also be useful as fillers preferably in the silicone component in emulsions, especially in cosmetic compositions. As is generally known, emulsions comprise at least two immiscible phases one of which is continuous and the other which is discontinuous. Further emulsions may be liquids with varying viscosities or solids. Additionally the particle size of the emulsions may be render them microemulsions and when sufficiently small microemulsions may be transparent. Further it is also possible to prepare emulsions of emulsions and these are generally known as multiple emulsions. These emulsions may be:
1) aqueous emulsions where the discontinuous phase comprises water and the continuous phase comprises a silicone;
2) aqueous emulsions where the continuous phase comprises a silicone and the discontinuous phase comprises water;
3) non-aqueous emulsions where the discontinuous phase comprises a non-aqueous hydroxylic solvent and the continuous phase comprises a silicone; and
4) non-aqueous emulsions where the continuous phase comprises a non-aqueous hydroxylic organic solvent and the discontinuous phase comprises a silicone.

Non-aqueous emulsions comprising a silicone phase are described in U.S. Pat. Nos. 6,060,546 and 6,271,295 the disclosures of which are herewith and hereby specifically incorporated by reference.

As used herein the term “non-aqueous hydroxylic organic compound” means hydroxyl containing organic compounds exemplified by alcohols, glycols, polyhydric alcohols and polymeric glycols and mixtures thereof that are liquid at room temperature, e.g. about 25° C., and about one atmosphere pressure. The non-aqueous organic hydroxylic solvents are selected from the group consisting of hydroxyl containing organic compounds comprising alcohols, glycols, polyhydric alcohols and polymeric glycols and mixtures thereof that are liquid at room temperature, e.g. about 25° C., and about one atmosphere pressure. Preferably the non-aqueous hydroxylic organic solvent is selected from the group consisting of ethylene glycol, ethanol, propyl alcohol, iso-propyl alcohol, propylene glycol, dipropylene glycol, tripropylene glycol, butylene glycol, iso-butylene glycol, methyl propane diol, glycerin, sorbitol, polyethylene glycol, polypropylene glycol mono alkyl ethers, polyoxyalkylene copolymers and mixtures thereof.

The personal care applications where hollow silica particles or “shells” of the present invention may also be useful and the silicone compositions derived therewith may be employed include, but are not limited to, deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreen, insect repellent and anti-aging products, color cosmetics such as lipsticks, foundations, face powders, eye liners, eye shadows, blushes, makeup, mascaras and other personal care formulations where silicone components have been conventionally added, as well as drug delivery systems for topical application of medicinal compositions that are to be applied to the skin.

The hollow silica particles or “shells” of the present invention may also be useful as fillers for various polymers, in order to modify the density, thermal behavior, optical properties, viscosity, processability, or other physical properties. The shells may also be useful as templates or supports for the growth of shells of other materials, such as metallic shells. The metallic shells may comprise Cu, Ag, Au, and the like, the properties of which are dependent upon the metal shell thickness. Deposited/grafted/reacted shells may also be polymeric in nature. Therefore, the present invention further contemplates the presence of a plurality of coatings over the particle template. The template may be removed after a single coating has been deposited onto the first coating. In addition, a plurality of coatings may be deposited over the particle template core before removal of the core, provided that they do not prevent the removal of the core. In the case where a metallic layer may be employed, it is to be understood that the present invention contemplates the deposition of the metallic and non-metallic layers in any useful order depending upon the desired resulting effect.

### EXAMPLE 1

Production of Polystvrene Latex

(50 L scale)

A 29.3 L aliquot of water purified with a Milli-Q® system was deposited into a 50 L glass-lined reactor equipped with an overhead condenser and overhead mechanical stirrer. The water was sparged for 40 minutes with nitrogen. A 4.97 g sample of potassium persulfate (Aldrich, St. Louis, Mo.) predissolved in 50 mL of water was added and the reaction mixture was heated to 70° C. while stirring at 250 RPM under a nitrogen blanket. A 4.0 L sample of styrene (Aldrich, St. Louis, Mo.) that was run through a neutral alumina column to remove the inhibitor was then added while stirring at 140 RPM. This was allowed to react for 24 hours at 70° C. while stirring at 140 RPM under a nitrogen blanket. After the reaction was complete, the reaction mixture was removed from the heat, and the percent solids was determined gravimetrically. The particle size distribution of the product was determined using dynamic light scattering.

### EXAMPLE 2

Coating of Polystyrene Latex Particles

(50 L scale)

A 6.75 kg charge of polystyrene latex containing 9.5% solids was added to a 50 L glass-lined reactor containing 26.0 L of water purified with a Milli-Q® system to form a reaction mixture containing 2% polystyrene by mass. The pH was adjusted using 578 mL of 28-30% aqueous ammonium hydroxide. The reaction mixture was then heated to 50° C., while stirring with an overhead mechanical mixer at 141 RPM. When the reactor reached 50° C., 70 mL of phenyltrimethoxysilane (94%, Aldrich, St. Louis, Mo.) was added to the reaction at a rate of 14 mL/min and allowed to react for 45 minutes. A solution containing 6.87 L of tetraethoxysilane and 8.12 L of absolute ethanol was prepared and added at a rate of 641 mL/hour while stirring at a rate of 141 RPM and maintaining a temperature of 70° C. The reaction mixture was removed from the reactor and passed through a coarse cloth filter-24 hours after the start of the addition of the tetraethoxysilane/ethanol mixture. The product was isolated by centrifugation, then air dried to remove water and ethanol.

### EXAMPLE 3

Core Removal

To remove their polystyrene core, the particles produced in Example 2 were spread in evaporating dishes and heated in a programmable furnace, bringing the temperature up to 425° C. at a rate of 1.9° C./min, and holding it at that temperature for 4 hours. The temperature was then increased to 580° C. at a rate of 1.7° C./min and heated for 5 hours. The furnace was then allowed to cool to room temperature at its maximum rate.

### EXAMPLE 4

HMDZ Treatment

124 g of hollow-sphere silica were divided into six roughly equal portions of approximately 20 g each. Each portion was suspended in 100 mL tetrahydrofuran (THF) and treated with 5 mL hexamethyldisilazane (HMDZ). In a 250 mL conical flask, each portion was homogenized for 10 min at approximately 9000 RPM with an Omni homogenizer equipped with a 10 mm stainless steel rotor-stator tip. The combined portions were added to a 2 liter round-bottomed flask equipped with a water-cooled reflux condenser, a large magnetic stir bar, a Teflon-coated thermocouple, a temperature-monitored heating mantle, and a nitrogen flush. The mixture was heated and held at a gentle reflux for 1 hour with vigorous stirring. After one hour, 500 mL of Isopar-G (Exxon-Mobil) and 50 mL of deionized water were added to the mixture. The reflux condenser was replaced by a compact vacuum-jacketed distillation head equipped with a thermometer and a 500 mL receiver flask. The mixture was again heated, and THF was allowed to slowly distill off. As the distillation slowed, the temperature of the mixture was increased to maintain a constant rate. The distillation receiver was periodically emptied. The pot temperature was held at 100° C. for approximately 30 min before the temperature was slowly increased to 165° C. and held at that temperature for approximately 12 hours. The temperature was then again raised until Isopar-G began to distill (170-180° C.). After 100 mL of Isopar-G had collected, the reaction mixture was removed from heat and decanted in portions into rectangular alumina crucibles. The volatiles were stripped from this material in a vacuum oven at 100° C. for 48 hours until the material was a largely solid mass. The combined material was then lightly ground and placed in the vacuum oven at 170-180° C. for 72 hours in a large Pyrex dish. The total amount of material recovered was 120.1 g.

### EXAMPLE 5

Water-In-Oil Cosmetic Product.

The material of the invention can be used to formulate cosmetic products that are physically stable, with excellent skin feel, and that can provide a high “covering power”. High covering power is generally achieved by the incorporation of an opacifier into the formulation. Titanium dioxide is widely considered to be an effective opacifying agent in cosmetic applications.

a.) Composition

| Ingredient | (I) | (II) |
|---|---|---|
| Part A | | |
| Cyclopentasiloxane (and) PEG/PPG-20-15 | 5 | 5 |
| Dimethicone (SF 1540) | | |
| Cyclopentasiloxane (and) C30-45 Alkyl | 10 | 10 |
| Cetearyl Dimethicone Crosspolymer (Velvesil 12) | | |
| Part B | | |
| Deionized Watear | 52.2 | 52.2 |
| Polysorbate-20 | 0.2 | 0.2 |
| Sodium Chloride | 0.1 | 0.1 |
| Cyclopentasiloxane (SF 1202) | 22 | 22 |
| SF 96-200 | 5 | 5 |
| Hollow Silica Spheres (HMDZ treated, | — | 5 |
| sample # 1067-58-1) | | |
| Titanium Dioxide KOBO BTD-401 Ti02 an | 5 | — |
| dIsopropyl Titanium Triisostearate | | |
| Sorbitan Oleate | 0.5 | 0.5 |

b.) Process for Making

The compositions described were made via two different processes (Process X and Process Y) detailed below.

Process X

1. In a beaker held at 60C, combine the ingredients of Part A, in the order shown, thoroughly mixing each component using an overhead stirrer/mixing blade at 700 rpm until homogeneous before adding the next ingredient.
2. In a separate vessel, combine ingredients of Part B in the order listed. Heat to 60C and mix at 700 rpm until homogeneous.
3. Slowly add Part B to Part A with good mixing. Maintain the temperature at 60C and increase the mix speed to 1000 rpm for 30 min.
4. Pour into suitable containers
   Process Y
1. Combine the first and second ingredients of Part A and mix in a SpeedMixer (model DAC 150 FVZ, ex Flack-Tek Inc) for 5 minutes at a speed of 2000 rpm.
2. Add the third and fourth ingredients of Part A into the same container as the mixture above , and mix in the SpeedMixer for 5 minutes at a speed of 2000 rpm.
3. Into the same container add the pigments and the sorbitan oleate, and mix in the SpeedMixer for 5 minutes at a speed of 2000 rpm.
4. Mix Part B in a plastic beaker.
5. Add Part B to the container containing Part A. Close the container and shake by hand. Mix in the SpeedMixer for 5 minutes at a speed of 2000 rpm and then for 5 more minutes at a speed of 3000 rpm. Mix at 3000 rpm for successive 5 minute time intervals until the sample is fully mixed.
   c) Evaluation of Hiding Power.

A contrast ratio as determined via Leneta Opacity charts can be used as a measure of the “hiding power” of a skin cosmetic composition. The contrast ratio of the inventive composition (II) was compared to the contrast ratio of the comparative composition (I) using Leneta Opacity charts (Form 2A ex Paul Gardner Co.) placed on a vacuum table and using an 8-path wet film applicator to draw down a film having a thickness of 7 MIL. The formulations (I) and (II) were prepared according to the Process Y, above.

The contrast ratio was determined via a Hunterlab ColorQuest-XE spectrophotmeter, and is defined as the ratio given by the value of “L” measured on the black background divided by the value of “L” measured on the white background.

TABLE 1
Contrast Ratio of Cosmetic Compositions.

| Formulation | Contrast Ratio |
|---|---|
| Comparative composition (I) | 0.44 |
| Inventive Composition (II) | 0.83 |

The inventive composition (II) had a contrast ratio that is significantly higher than that observed for the comparative composition (I), (0.83 compared to 0.44). Thus, the hiding power of the inventive composition is significantly greater than the hiding power of the comparative composition formulated with titanium dioxide.

### EXAMPLE 6

Water-in-oil Cosmetic Foundation Product.

The material of the present invention can be used to formulate cosmetic foundation products that are physically stable, and which have an excellent skin feel, and that can provide a high “covering power” in a skin cosmetic application.

a.) Composition

| Ingredient | III | IV | V | VI | VII | VIII |
|---|---|---|---|---|---|---|
| Part A | | | | | | |
| Cyclopentasiloxane (and) PEG/PPG-20-15 Dimethicone (SF 1540) | 5 | 5 | 5 | 5 | 5 | 5 |
| Cyclopentasiloxane (and) Dimethicone | 10 | 10 | 10 | 10 | 10 | 10 |
| C30-45 Alkyl Cetearyl Crosspolymer (Velvesil ® 125) | | | | | | |
| Cyclopentasiloxane (SF 1202) | 22 | 22 | 22 | 22 | 22 | 22 |
| SF96-200 | 5 | 5 | 5 | 5 | 5 | 5 |
| Hollow Silica Spheres (HMDZ treated; sample # 1067-58-1) | — | — | — | 2.5 | 5.0 | 7.5 |
| Titanium Dioxide TRI-K Industries Microtitan 100T | 2.5 | 5.0 | 7.5 | — | — | — |
| Yellow Iron Oxides KOBO BYO-12 Iron Oxide (C.I. 77492) | 1.3 | 1.3 | 1.3 | 1.3 | 1.3 | 1.3 |
| and Isopropyl Titanium Triisostearate | | | | | | |
| Red Iron Oxides KOBO BRO-12 Iron Oxide (C.I. 77491) | 0.6 | 0.6 | 0.6 | 0.6 | 0.6 | 0.6 |
| and Isopropyl Titanium Triisostearate | | | | | | |
| Black Iron Oxides KOBO BBO-12 Iron Oxide (C.I. 77499) | 0.1 | 0.1 | 0.1 | 0.1 | 0.1 | 0.1 |
| and Isopropyl Titanium Triisostearate | | | | | | |
| Sorbitan Oleate | 0.5 | 0.5 | 0.5 | 0.5 | 0.5 | 0.5 |
| Part B | | | | | | |
| Deionized Water | 52.7 | 50.2 | 47.7 | 52.7 | 50.2 | 47.7 |
| Polysorbate-20 | 0.2 | 0.2 | 0.2 | 0.2 | 0.2 | 0.2 |
| Sodium Chloride | 0.1 | 0.1 | 0.1 | 0.1 | 0.1 | 0.1 |

b.) Process for Making

Formulations (III-VIII) were made according to Process Y, as set forth in Example 1.

c) Evaluation of hiding power.

An assessment of the hiding power of these skin cosmetic foundation formulations was obtained by measuring the contrast ratio as described in 1(c). The results are reported in Table 2.

TABLE 2
Contrast ratio of skin cosmetic foundation formulations.

| Comparative Formulations | | | Inventive Formulations | | |
|---|---|---|---|---|---|
| III | IV | V | VI | VII | VIII |
| 0.83 | 0.86 | 0.92 | 0.91 | 0.99 | 1.0 |

The inventive compositions (VI-VIII) had a contrast ratio that is significantly higher than that observed for the comparative compositions (III-V), i.e. 0.91-1.0 compared to 0.83-0.92. Thus, at a given level of primary opacifier in these formulations (i.e. 0.25, 0.5, 0.75%), the hiding power of the composition formulated with the material of the invention is significantly greater than the hiding power of the comparative composition formulated with titanium dioxide.

Although particular embodiments of the invention have been described and illustrated herein, it is recognized that modifications and variations may readily occur to those skilled in the field, and consequently, it is intended that the appended claims be interpreted to cover such modifications and equivalents.

We claim:

1. A method for making a hollow silica-containing particle comprising the steps of:
(a) creating a template particle;
(b) providing a coupling agent to the template particle surface;
(c) providing a silicon-containing compound to deposit a silica-containing shell on the template particle to create a substantially uniform coating on the template particle; and
(d) eliminating the template particle by first heating said template particle to a first temperature of from about 325° C. to about 525° C. for a first time period, and then heating said particle to a second temperature of from about 525° C. to about 900° C. for a second time period thereby making a hollow silica particle.

2. The method of claim 1, wherein the template particle comprises a polymeric material.

3. The method of claim 1, wherein the template particle comprises a polymeric material composed of monomers selected from the group consisting of, styrene, alphamethylstyrene, and mixtures thereof.

4. The method of claim 1, wherein the template particle is polystyrene.

5. The method of claim 1, wherein the template material is in an aqueous suspension having a pH adjusted to a pH range of from about 8 to about 12.

6. The method of claim 1, further comprising the step of providing an initiator, said initiator selected from the group consisting of persulfate salts, organic hydroperoxides and azo initiators.

7. The method of claim 1, wherein the template particle is created in the absence of surfactant.

8. The method of claim 1, wherein the template particle creation step further comprises the step of providing a surfactant selected from the group consisting of alkyl sulfates, alkyl sulfonates, linear alkyl arylsulfonates, and mixtures thereof.

9. The method of claim 1, further comprising the step of:
providing a compatibilizing agent to the template selected from the group consisting of phenyltrialkoxysilane and (3-aminopropyl)trialkoxysilane.

10. The method of claim 1, wherein the silicon-containing compound condensed on the template particle is selected from the group consisting of tetraalkoxysilanes, dialkoxysilanes, alkoxysilanes, silicates, colloidal silica, silicone oligomers, oligomeric silsesquioxanes and silicon polymers.

11. The method of claim 1, wherein the silicon-containing compound is selected from the group consisting of tetraethoxysilane, tetrapropoxysilane, and tetramethoxysilane.

12. The method of claim 1, wherein the average particle size of the template particle is in the range of from about 200 nm to about 700 nm.

13. The method of claim 1, wherein the average particle size of the template particle is in the range of from about 250 nm to about 600 nm.

14. The method of claim 1, wherein the template particle is eliminated by first heating said template particle to a first temperature of from about 375° C. to about 475° C. for a first time period of from about 2 to about 6 hours, and then heating said particle to a second temperature of from about 550° C. to about 700° C. for a second time period of from about 2 to about 6 hours.

15. The method of claim 1, wherein the first and second temperatures are achieved by employing a temperature ramp rate of from about 1° C./min to about 10° C./min.

16. The method of claim 1, wherein the resulting hollow silica-containing particle is white in color after the template particle has been eliminated.

17. A particle made according to the method of claim 1.

18. A material comprising particles made according to the method of claim 1 wherein said particles are substantially impermeable to decamethylcyclopentasiloxane wherein said material is not a cosmetic material.

19. A method for making a hollow silica-containing particle comprising the steps of:
(a) creating a template particle having an average particle size of from about 250 nm to about 600 nm;
(b) providing a coupling agent to the template particle surface;
(c) providing a silicon-containing compound to deposit a silica-containing shell on the template particle to create a substantially uniform coating on the template particle; and
(d) eliminating the template particle by first heating said template particle to a first temperature of from about 375° C. to about 475° C. for a first time period of from about 2 to about 6 hours, and then heating said particle to a second temperature of from about 550° C. to about 700° C. for a second time period of from about 2 to about 6 hours; thereby making a hollow silica particle.

20. A hollow silica particle made from a composition comprising a silicon-containing compound selected from the group consisting of tetraalkoxysilanes, trialkyloxysilanes and derivatives thereof, dialkoxysilanes and derivatives thereof, alkoxysilanes and derivatives thereof, silicone oligomers, oligomeric silsesquioxanes and silicone polymers, said particle having a substantially uniform particle size and said hollow silica particle being white in color and being substantially impermeable to decamethylcyclopentasiloxane.

21. The particle of claim 20 wherein the particle has an average particle size of from about 200 nm to about 700 nm.

22. The particle of claim 20, wherein the particle has an average particle size of from about 250 nm to about 600 nm.

23. The particle of claim 20, wherein the particle is substantially spherical.

24. The particle of claim 20, wherein the particle comprises a shell made from at least one coating, said shell having a substantially constant thickness of from about 10 nm to about 30 nm.

25. The particle of claim 20, further comprising a plurality of coatings, each coating having a substantially constant thickness.

26. The particle of claim 20, wherein the particle comprises an outer surface functionalized with a material comprising organosilyl groups.

27. The particle of claim 20, wherein the particle comprises an outer surface functionalized by reacting the surface with hexamethyldisilazane.

28. The particle of claim 20, wherein the hollow silica particle further comprises a chemical functionality selected from the group consisting of olefins, esters, amines, acids, epoxides, alcohols and mixtures thereof.

29. The particle of claim 24 wherein at least one coating comprises a metallic formulation.

30. The particle of claim 29, wherein the metallic formulation comprises a material selected from the group consisting of copper-containing, silver-containing, gold-containing compounds, and mixtures thereof.

31. A material comprising the particle of claim 20 wherein said particles are substantially impermeable to decamethylcyclopentasiloxane wherein said material is not a cosmetic material.
